(19) United States
(12) Patent Application Publication
(10) Pub. No.: US 2019/0138797 A1
(43) Pub. Date: May 9, 2019

(54) CONFIGURATION SYSTEM AND METHOD

(71) Applicants: Mindtronic AI Co.,Ltd., Grand Cayman (KY); Shanghai XPT Technology Limited, Shanghai City (CN)

(72) Inventors: Mu-Jen Huang, Taipei City (TW); Ya-Li Tai, Taoyuan City (TW); Yu-Sian Jiang, Kaohsiung City (TW)

(21) Appl. No.: 16/183,744

(22) Filed: Nov. 8, 2018

Related U.S. Application Data
(63) Continuation-in-part of application No. 15/935,053, filed on Mar. 25, 2018.

(30) Foreign Application Priority Data
Nov. 9, 2017 (CN) 201711099567.9
Nov. 9, 2017 (CN) 201721487383.5
Nov. 30, 2017 (CN) 201711240893.7
Nov. 30, 2017 (CN) 201721643439.1
Mar. 21, 2018 (CN) 201810237040.6
Mar. 21, 2018 (CN) 201820387687.2

(51) Int. Cl. G06K 9/00; G06K 9/62

(52) U.S. Cl. CPC G06K 9/00335; G06K 9/00315; B60R 16/037; G06K 9/00288; G06K 9/00926; G06K 9/6201

(57) ABSTRACT

A configuration system provided to configure the setting of facilities in a vehicle. A registered user enrolls a default facial motion and associated with the default facial motion with a configuration profile containing configurations of some of or all of the facilities. The registered user's facial information obtained from the default facial motion is stored in a storage module of the configuration system. When a user sits into the vehicle and makes a facial motion, an image capture module of the configuration system captures the facial motion. An image processing module of the configuration system retrieves facial information of the user based on the facial motion. The image processing module further compares the user's facial information with the registered user's facial information. If the two approximately match, a control unit of the configuration system modifies the settings of the facilities conforming with the configuration profile.

### CROSS REFERENCE TO RELATED APPLICATIONS

This patent application is a continuation-in-part (CIP) of U.S. patent application Ser. No. 15/935,053 filed on 25 Mar. 2018. The present application is based on and claims priority to U.S. patent application Ser. No. 15/935,053 filed on 25 Mar. 2018, which is incorporated by reference herein.

### BACKGROUND OF THE INVENTION

### 1. Field of the Invention

The present invention relates to a vehicle configuration system and an associated method, and more particularly to a vehicle configuration system and an associated method that modifies settings of facilities in a vehicle based on facial motions.

### 2. Description of the Prior Art

Technological developments have led to the implementation of what is known as a sharing economy in many societies. A vehicle-sharing service or a vehicle rental service allows users to share a vehicle without purchasing it.

Different users, however, may have different preferences regarding vehicle configurations. The problem of sharing a vehicle with others is whenever a user is ready to use a shared vehicle, he/she has to modify the settings to fit his/her own preferences and/or body. This may take time especially when the model of the shared vehicle is new to the user, and he/she is not familiar with the configurations.

### SUMMARY OF THE INVENTION

Exemplary embodiments of systems, methods, and apparatus for configuring facilities in a vehicle based on a facial motion are described herein.

The described techniques can be implemented separately, or in various combinations with each other. As will be described more fully below, the described techniques can be implemented on a variety of hardware devices having or being connected to an image capture module.

In one exemplary embodiment disclosed herein, settings of facilities in a vehicle are configured based on facial motions. The configuration system includes: a storage module, an image capture module, an image processing module, and a control unit. The storage module stores a registered user's facial information and a configuration profile. The configuration profile is associated with a default facial motion made by the registered user and the facility's setting. The image capture module captures a facial motion made by a user. The image processing module determines the user's facial information based on the facial motion, and further to compares the user's facial information with the registered user's facial information. The control unit modifies the facility's setting conforming with the configuration profile if the user's facial information approximately matches the registered user's facial information.

In another exemplary embodiment, a method for configuring settings of facilities based on facial motions is disclosed herein. The method includes the followings steps: storing facial information of a registered user and a configuration profile, wherein the configuration profile is associated with a default facial motion made by the registered user and the facility's setting; capturing a facial motion made by a user; retrieving the user's facial information based on the facial motion; comparing the user's facial information with the registered user's facial information; and modifying the settings of the facilities conforming with the configuration profile if the user's facial information approximately matches the registered user's facial information.

This summary is provided to introduce a selection of concepts in a simplified form that is further described below. This summary is not intended to identify key features or essential features of the claimed subject matter, nor is it intended to be used as an aid in determining the scope of the claimed subject matter. Additional features and advantages of the disclosed technology will be made apparent from the following detailed description of embodiments that proceeds with reference to the accompanying drawings.

### BRIEF DESCRIPTION OF THE DRAWINGS

FIG. 1 is a schematic diagram showing a configuration system.

FIG. 2 is an exemplary diagram showing at least one facial features of a user.

FIG. 3 is an exemplary diagram showing a facial motion performed by a user.

FIG. 4 is an exemplary diagram showing a variation of the selected facial features over the facial motion.

FIG. 5A is an exemplary flowchart of establishing a database containing a registered user's facial information, facial motions and associated configuration profiles.

FIG. 5B is an exemplary flowchart of configuring facilities in a vehicle.

FIG. 6 is another schematic diagram of a configuration system.

FIG. 7 is another schematic diagram of a configuration system.

FIG. 8 is another schematic diagram of a configuration system.

FIG. 9 is another schematic diagram of a configuration system.

FIGS. 10A and 10B are exemplary database demonstrating various users' facial motions associated with various configuration profiles.

### DETAILED DESCRIPTION

To provide a better understanding of the present invention, preferred embodiments will be detailed as follows. The preferred embodiments of the present invention are illustrated in the accompanying drawings with numbered elements to elaborate on the contents and effects to be achieved. It should be noted that the drawings are simplified schematics, and therefore show only the components and combinations associated with the present invention, in order to provide a clearer description of the basic architecture or method of implementation. The components would be complex in reality. In addition, for ease of explanation, the components shown in the drawings may not represent their actual number, shape, and dimensions; details can be adjusted according to design requirements.

In view of the foregoing, the technology described hereinafter discloses a configuration system and a method that configure the settings of devices installed in a vehicle based on facial motions. Specifically, the system and the method of the present invention associate a facial motion with a configuration profile containing one or more settings of the device(s) installed in a vehicle.

The operation of the invention requests users to register and establish configuration profiles. Specifically, a user pre-enrolls one or more facial motion and associates the facial motion(s) with a configuration of a device, i.e. the configuration profile. The configuration profile contains one or more setting(s) regarding facilities and is stored in a database in a storage of the configuration system.

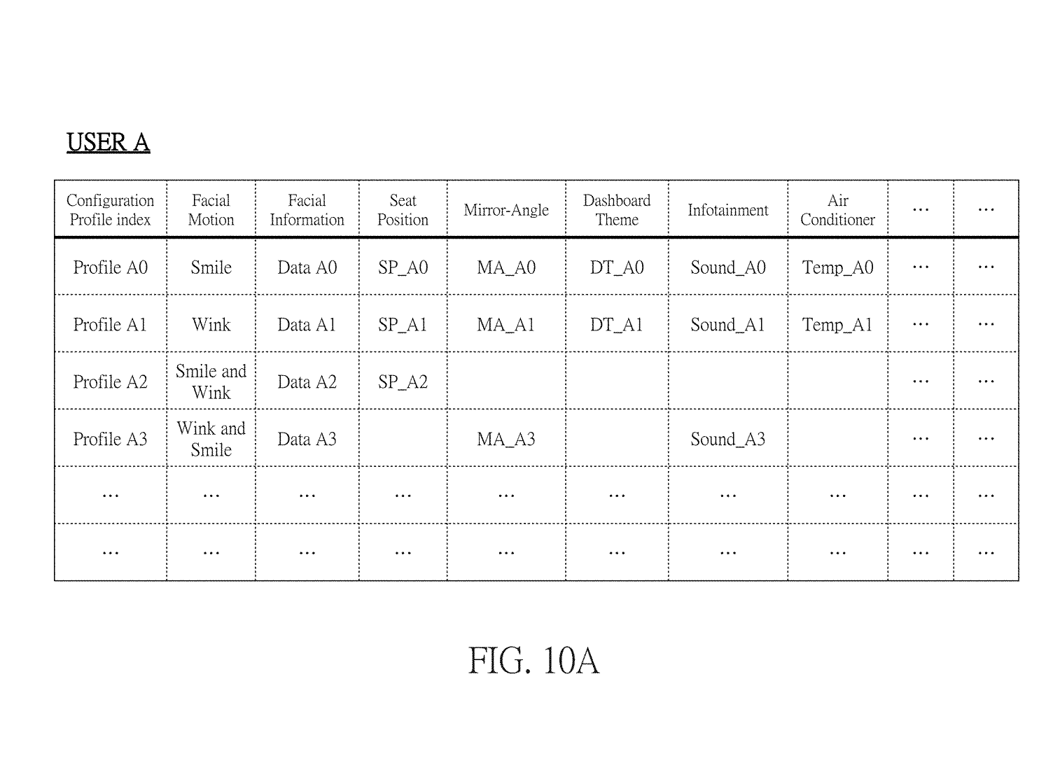

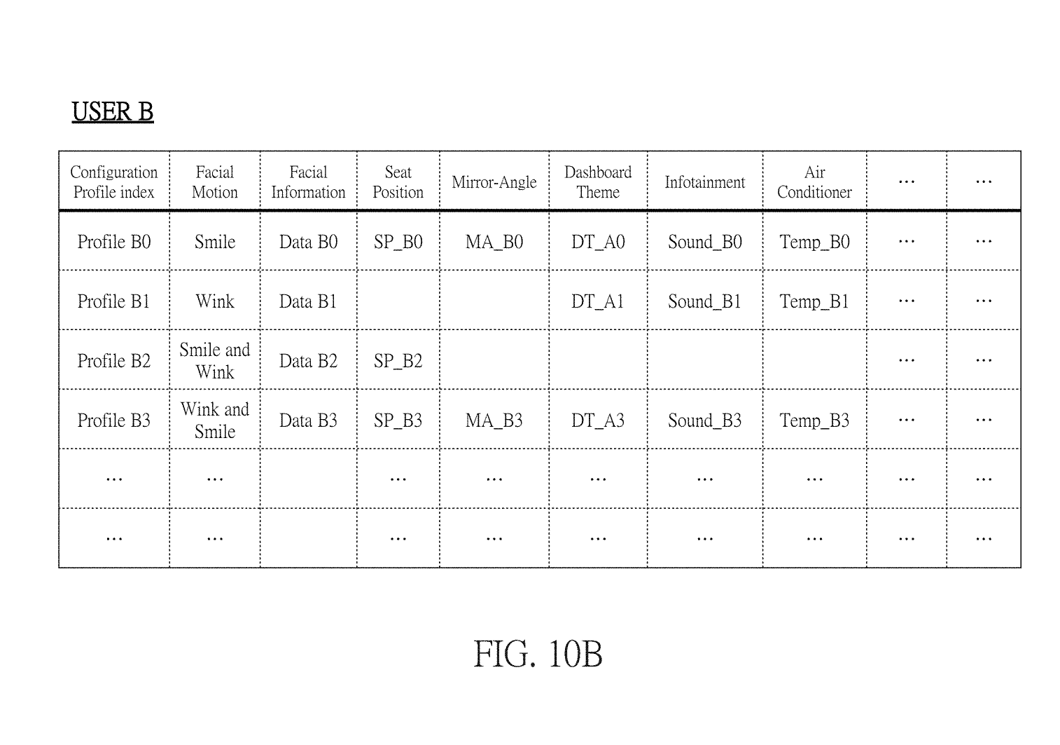

An example of configuration profiles is depicted in FIG. 10A. As shown, User A may register to the configuration system of the present invention. As shown, User A may enroll one or more facial motions, such as a smile, a wink, etc., and each of the facial motion is associated with a configuration profile. For instance, a smile is related to modify the settings of the seat to the position SP_A0, the angles of the mirror to MA_A0, the theme of the dashboard to DT_A0 (e.g. winter theme), the display of the soundtrack Sound_A0 (e.g. the news channel) from the infotainment and adjust the vehicle temperature to Temp_A0 (e.g. 27° C.) through the operation of the air conditioner. Similarly, another configuration profile linking to a wink is also provided in FIG. 10A. Thus, if User A winks, the configuration system will also modify the settings of the relevant facilities accordingly. It should be noted that the binding facial motion may be constituted by a series of facial expressions to increase the complexity and reduce the false recognition. For instance, as shown in FIG. 10A, a facial motion constituted by a smile followed by a wink is enrolled and associated with a configuration profile—Profile A2; while another facial motion constituted by a wink followed by a smile is enrolled and associated with another configuration profile—Profile A3. Besides, it should also be noted a configuration profile may only relevant to some, rather than all, of the facilities installed in the vehicle. For example, as also shown in FIG. 10A, the only facility subject to modification in accordance with the configuration profile—Profile A2 is the seat position. That is, if User A smiles and winks, only the seat he/she is sitting on will be moved to the position SP A2. Similarly, if User A winks and smiles, the configuration system changes the settings of the angles of the mirrors and the music the infotainment plays according to the configuration profile—Profile A3.

In the present invention, more than one users may register to the configuration system. FIG. 10B shows the configurations profiles of User B as an example to demonstrate another example of the present invention.

Moreover, in another occasion, a universal facial motion may link to various configurations profiles of different users. For instance, when a vehicle ignites, the driver of the vehicle may be asked to smile (i.e. the universal facial motion in the instance exampled) to configure the vehicle. The configuration(s) may include an adjustment of the driver's seat and the angles of the mirrors to fit the user's body, a change of theme of the dashboard, a play of the user's favor audio channel, and an adjustment of the vehicle temperature. In brief, the settings of the devices in the vehicle are associated with the same facial motion, and different users have different profiles regarding the settings of the devices. For example, assuming the universal facial motion is a smiling, as shown in FIGS. 10A and 10B, User A and User B may have different configuration profiles toward the same facilities. Thus, if a user in the vehicle smiles, the present invention operates to determine who the user is (i.e. through some sort of facial recognition processes which will be discussed later). If it is determined that the user is User A, the system and the method of the present invention operate to modify the facilities of the vehicle according to with A's configuration profile—Profile A0 which A has established previously. On the other hand, if it is determined that the user is User B, the system and the method of the present invention operate to change the settings of the vehicle to Profile BO which B has set up before. To sum up, any user who steps into the vehicle may perform the same facial motion. Depending on the identity of the user, the present invention operates to modify the configuration(s) of the vehicle accordingly. Similarly, the default facial motion may be a series of facial motions instead.

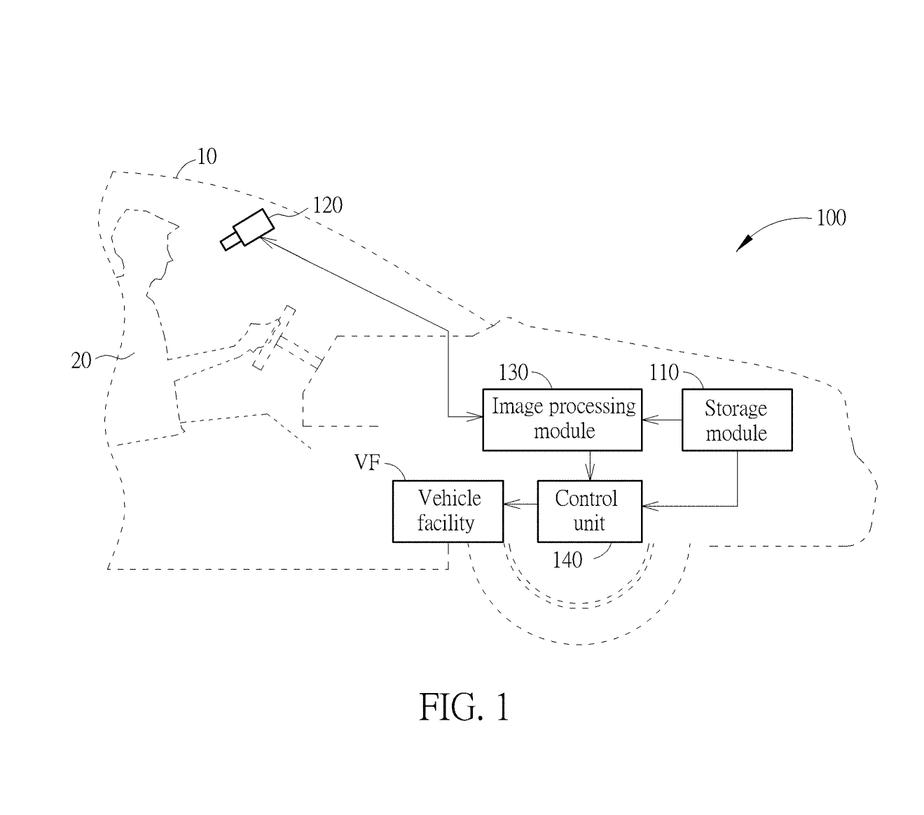

FIG. 1 illustrates an exemplary structure of configuration system 100 in which embodiments of the disclosed technology can be implemented. The configuration system 100 is not intended to suggest any limitation as to the scope of use or functionality of the disclosed technology, as the technology can be implemented in diverse general-purpose or special-purpose computing environments. The disclosed technology may also be practiced in distributed computing environments where tasks are performed by remote processing devices that are linked through a communications network (e.g., a cloud computing network). In a distributed computing environment, programs may be in both local and remote memory storage devices.

With reference to FIG. 1, the configuration system 100 is installed in a vehicle 10 where one or more vehicle facilities VFs also equipped therein are configured based on one or more configuration profiles associated with facial motions made by a user (i.e. here, for example, the driver) 20. The configuration system 100 includes a storage module 110, an image capture module 120, an image processing module 130 and a control unit 140. Although as shown in FIG. 1, the storage module 110, the image capture module 120 and the image processing module 130 are disposed in the vehicle 10 and are electrically or wirelessly connected; it should however be understood that the illustration of FIG. 1 is a mere example and should under no circumstance become a limitation to the described technologies. For instance, image processes may be conducted by an image processing unit disposed remotely, and the results therefore obtained are transmitted to the configuration system 100 through some sort of communication arrangement.

Bask to FIG. 1, firstly, the image capture module 120 is provided to capture facial images of the user 20 who has registered his/her identity to the configuration system 100. The image capture module 120 may be implemented by various kinds of cameras either disposed internally or externally in the vehicle 10. If the image capture module 120 is an internal camera, it may be placed at a location where it will be convenient to capture the user's face. For instance, the image capture module 120 may be disposed on a windshield or a roof of the vehicle 10. If the image capture module 120 is an external camera, it may be a camera of a mobile phone capable of transmitting captured facial images to the configuration system 100 through some sort of communication equipment and protocols. In one instance, the user 20 may hand held the mobile device and perform a particular facial motion toward the camera. The mobile device consequently transmits the captured images to the image processing module 130 of the configuration system 100. The user 20, although illustrated as the driver of the vehicle 10, may be any passenger sitting in the vehicle 10.

Moreover, the image processing module 130 is provided to perform facial recognition based on the facial images captured by the image capture module 120. The image processing module 130 is electrically connected to or wirelessly connected to the image capture module 120 and the storage module 110. The image processing module 130 may be a processing unit capable of processing images. The image processing module 130 executes machine-readable instructions. In a multi-processor system, multiple processing units execute machine-readable instructions to increase processing power.

As shown in FIG. 1, the storage module 110 contains facial information of the user 20. The facial information is transformed from a facial motion associating with a configuration profile with respect to the vehicle facilities VFs. Although it shows only one vehicle facility VF in FIG. 1, it should be understood by skilled persons that there could be numbers of facilities also installed in the vehicle which settings may be changed through the operation of the present invention. Additionally, the vehicle facility VF may be the air conditioner, the infotainment, the scheme of the dashboard, the position of the seat, the angles of the mirrors, etc.

As mentioned above, a user needs to register his/her identity and configuration profiles to the configuration system 100 beforehand. He/she may enroll one or more facial motion(s) and associate each of the facial motions with a configuration profile to one or more facilities VFs as exampled in FIGS. 10A and 10B. The enrolled facial motions are transformed into facial information and stored in the storage module 110 together with the configuration profiles. It should be noted that more than one users may enroll various facial motions associating with different configurations of different facilities VFs as also demonstrated in FIGS. 10A and 10B.

The facial information may include a static facial information and a dynamic facial information. The static information contains data of the registered user's facial feature(s) in a static state; while the dynamic facial information contains data of the registered user's facial feature(s) in a dynamic state. More specifically, the dynamical facial information may be obtained by recording a source video clip where the registered user makes a facial motion over a time frame. The source video clip contains a plurality of source image frames of the registered user. The image processing module 130 extracts at least one facial feature(s) of the registered user from the source facial image frames and calculates a variation on the registered user's facial feature(s) over the time frame. The data of the facial feature(s) and the variation may be collectively stored as the registered user's facial information.

When a user 20 attempts to configure the vehicle 10, the image capture module 120 captures a video clip where the user 20 makes a facial motion over a time frame. The video clip may also contain a plurality of image frames. The image processing module 130 extracts at least one facial feature(s) from the image frames and calculate a variation on the user's facial feature(s) over the time frame. The variation of facial feature (s) is compared with the facial information stored in the storage unit 110. If the deviation between them is within a threshold, the control unit 140 goes on to adjust the configuration of the vehicle facility VF in accordance with the associated configuration profile also stored in the storage module 110.

There are many ways known to skilled persons to calculate the deviation, for example, without limitation, the time dynamic warping (DTW) technique. As aforementioned, the configuration profile may be to display the registered user's favor album, to reduce the room temperature of the vehicle 10 through the air conditioner to fit the user's preference, etc.

In one embodiment, the configuration system 100 may perform a two-step facial recognition. Specifically, the configuration system 100 may firstly verify if the user 20 in front of the image capture module 120 is a registered user. If so, the configuration system 100 then proceeds to figure out what configuration(s) of the vehicle should be made based on the facial motion made by the user 20. It should be noted that under the scope of the present invention, the first step of facial recognition is made based on a still facial image of the user 20, while a dynamic facial motion is based upon in the second step. In the two-step facial recognition, it is only when the user 20 is verified and the user 20 makes approximately the same facial motion that the associated configurations will be made to the associated facilities.

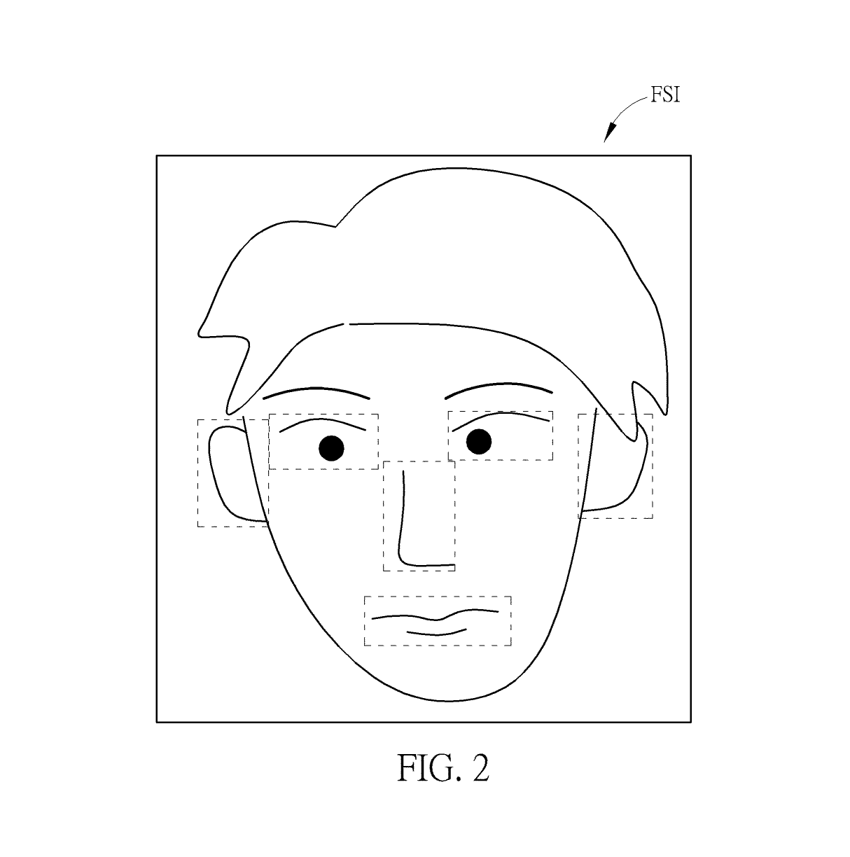

FIG. 2 illustrates a still image showing an implementation of facial recognition and extractions of facial feature (s) in accordance with the present invention. The facial recognition may be performed once or periodically. With also reference to FIG. 1, firstly, the image processing unit 130 obtains a static facial image FSI of the user 20. In one embodiment, the image FSI may be retrieved from one of the image frames of the video clip captured by the image capture module 120. Once obtained, the image processing unit 130 extracts at least one facial feature (s) from the image FSI. The facial feature (s) may be the shapes, the positions or the relative positions of, for example, the user's eyes, ears, mouth, nose or face contours, etc. obtained either in the two-dimension or the three-dimension domain depending on whether the static facial image FSI is a 2D or 3D image. Further, the image processing module 130 compares the data of the user's facial feature(s) against the database stored in the storage module 110 containing the registered users' facial information. It should be noted that the registered users' facial information may be obtained by the image capture module 120 in the same manner to establish the database. If the facial information of the user 20 matches (or approximately matches) one of the registered users' facial information, the image processing module 130 verifies that the user is as one of the registered users and goes on to decide what configuration profile should be performed based on the user's facial motion.

Apart from directly obtaining the facial feature(s) from the image frames of captured video clip, the facial feature(s) used to verify the identity of the user 20 may be obtained from other sources. For instance, they may be extracted from a still image separately and independently captured by the image capture module 120. Alternatively, they may be obtained through a binding device, such as the user's own cellphone, where his/her biometric data, including facial feature(s), are stored. When the configuration system 100 operates, the binding device sends over the biometric data through any sort of communication protocols to the configuration system 100 to verify the user 20. Further, the facial feature(s) may not be a single feature but a multiple or a combination of facial landmarks (or key points). The above is a mere example and should not to any extend become a limitation to the present invention.

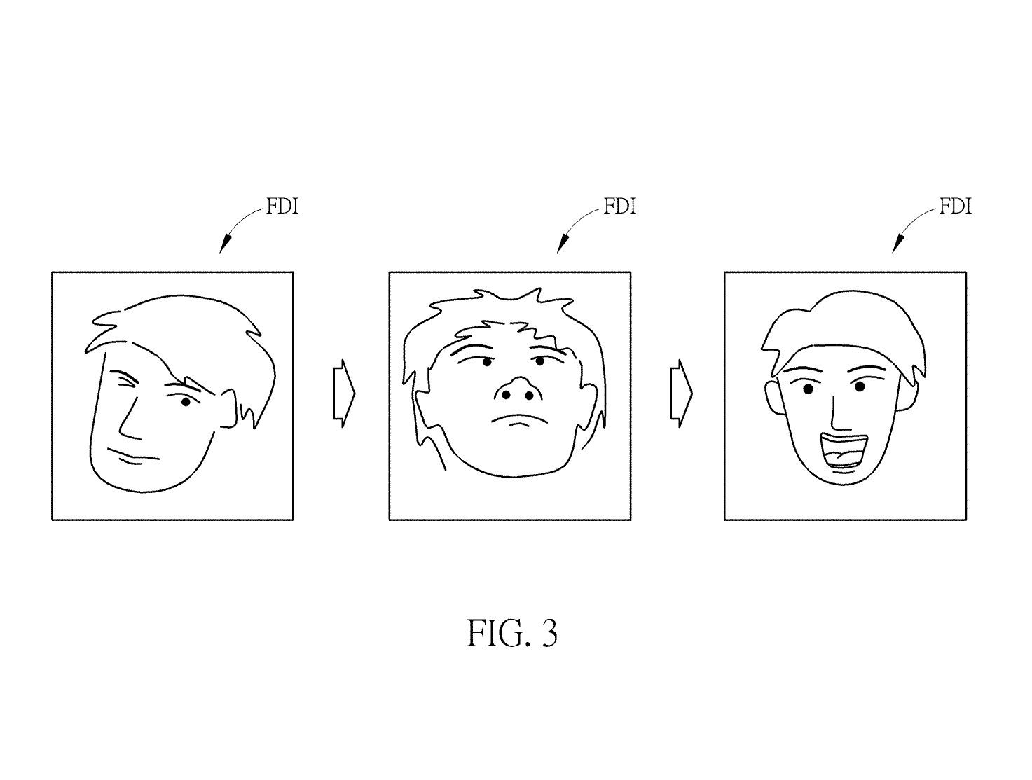

FIG. 3 illustrates another implementation of facial recognition based on a dynamic facial motion in accordance with the present invention. It should be noted that the dynamic facial recognition may be a standalone process and does not necessarily have to work in conjunction with the static facial recognition for the present invention to work. To begin with, a user may register his/her identity by recording a source video clip where he/she makes a series of facial expressions (such as winking, snout-up, and mouth-open) over a time frame that constitute a configuration profile associated with settings of the facilities in a vehicle. The source video clip contains a plurality of source image frames. The image processing module 130 extracts at least one facial feature(s) of the registered user in the same way discussed previously. The image processing module 130 then calculates a source variation on the registered user's facial feature (s) over the time frame. The source variation may be the changes on the shape and/or the position of the registered user's eyes, nose and mouth. The calculation may be made either in a two-dimension or a 3-D dimension model. The data of the registered user's facial feature(s) (i.e. static facial information) as well as the source variation (i.e. dynamic facial information) are stored in the database in the storage module 110.

When the user 20 attempts to modify the settings of the facilities installed in the vehicle 10 by making a facial motion containing winking, snout-up and mouth-open over a time frame, the image capture module 120 captures the facial motion as a video clip. The video clip includes a plurality of image frames collectively called a dynamic facial image FDT as shown in FIG. 3. The image processing module 130 extracts at least one facial feature(s) of the user 20 through the same way as stated in the discussion of FIG. 2. Alternatively, if the static facial recognition in conducted beforehand, the configuration system 100 may simply take the result as far as the facial feature extraction is concerned. The image processing unit 130 then calculates a variation of the user's facial feature(s) over the time frame. The variation may be the change on the shape and/or the position of the user's eyes, nose and lip. The calculation may be made either in a two-dimension or a 3-dimension model. For instance, the image processing unit 130 may first identify the shapes and/or positions of the user's eyes, lip and/or nose on the first image frame of the dynamic facial image FDT, and then calculates the variation(s) on the shape and/or (exact and/or relative) position of the eyes, lips and/or nose based on the rest image frames. The image processing unit 130 compares the variation of the user's facial feature(s) against the database where the registered users' facial information is stored to see if they (approximately) match. If the deviation between them falls within a threshold, the image processing module 130 goes on to modify one or more facilities installed in the vehicle 10 in accordance with the associated configuration profile. The technique of dynamic time warping (DTW) may be applied for the determination of the deviation.

The configuration system 100 provides a more secure and reliable way to modify the settings of facilities installed in a vehicle. Under the present invention, it will not be easy for anyone who looks like any of the registered users to change the configurations of the vehicle 10.

As discussed, since the user's facial feature(s) can be extracted from the image frames of the video clip, the user's identity can be verified simultaneously without additional authentication processes. Thus, although in the present invention the dynamic facial recognition serves to determine whether the vehicle configurations should be modified, the result can also be used to determine if the user 20 is any of the registered users. In other words, if the user's facial information matches the registered user's facial information, the user's identity is verified. So long as the variation of the user's facial feature(s) matches the source variation of the registered user's facial feature(s), it will be sufficient to verify the user and modify the vehicle configurations accordingly. That is, in one embodiment of the present invention, the static facial recognition may be skipped without negating the operation of the configuration system 100. Yet in another embodiment, the two-step facial recognition may still be conducted, and the overall recognition rate is decided by combining the results of the static and the dynamic facial recognition with difference weightings given to them.

FIG. 3 is a mere example showing show the user 20 may make a series of facial expressions (i.e. collectively they are facial motion) to constitute a configuration profile associating with the settings of the facilities. There may be other combination of facial expressions. For instance, the user may make facial expressions such as being wide-eyed, sticking the tongue out, and duck-faced, etc. Various combinations of facial expressions constitute various configuration profiles. The registered user may, depending on the preference and the desired complexity, choose one or some of the facial motions to modify the settings of the chosen facilities. The register user may also exaggerate facial motions, for instance, by making lip expressions of silent talk, to increase the complexity of the extraction of the facial features. In the present invention, the registered user may also move and/or rotate his/her head to enhance the variation(s) of facial feature(s) and therefore increase the security of false identification.

The recognition method adopted in the configuration system 100 may be any image processing techniques and/or algorithms known to the skilled persons in the field so long as they are able to fulfill the purpose of the present invention. Additionally, more than one techniques may be applied to the configuration system 100. The techniques may include, for instance and without limitation, machine learning computer vision, image processing and/or video processing. In one embodiment, one or more facial feature(s) may be extracted over a time frame. The variation on the facial feature(s) is observed over the time frame and is compared against the facial information stored in the storage module 110 to see if the deviation is within a threshold. The facial information may include the data of the registered user's one or more facial feature(s) that is able to distinguish the registered user from others. The facial feature may be a feature descriptor, facial landmarks (such as nose, eyes, lip, eyebrows, chin, cheek, etc.), or any combination of the above. The feature descriptor may include, without limitation, edges, histogram of gradient (HOG), local binary patterns (LBP), or key-points.

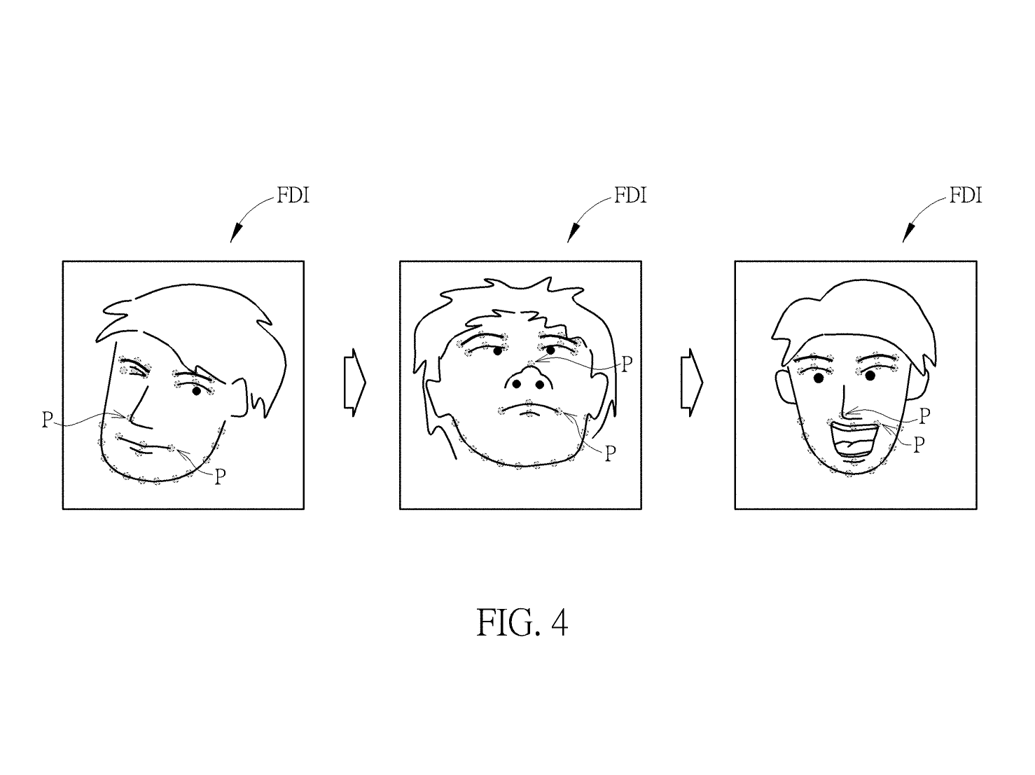

FIG. 4 illustrates a dynamic facial image FDI where the user's lip and nose tip are chosen as the facial landmarks P. As shown, the vector variation of the facial landmarks P in position (either in the two-dimension or the three-dimension domain) over a time frame can be determined and compared with the registered users' facial information stored in the database. It should be noted that the facial information should also contain the vector variation on the same facial landmarks P collected from the registered users. According to the present invention, the image processing module 130 compares the FDI where both the facial landmarks P and the variation over the time frame are obtained with the registered user's facial information to see if the deviation is within a threshold.

As mentioned above, in one embodiment, the facial landmarks P may be obtained from one of the image frames of FDI. Alternatively, they may be obtained from a still image separately and independently captured by the image capture module 120. Once the facial landmarks P are identified, the configuration system 100 calculates the vector variation of the user's facial landmarks P over the time frame. The variation is compared with the facial information of the registered users to determine whether the settings of the chosen facilities should be modified. Although only two facial landmarks P, nose tip and lip, are selected in the FIG. 4, one may adopt more facial landmarks to conduct the recognition in accordance with the present invention to enhance the accuracy.

There are various ways to determine if the variation of the user's facial features is identical to that of a registered user's. A technique called dynamic time warping (DTW) may be applied to determine the deviation. Taking a smile for example, one may tag 20 key points surrounding a registered user's mouth and record the positional changes on the key points over the registered user's smile. The positional changes altogether compose a smile track function—SFtn. When the user 20 attempts to modify the configurations of the vehicle 10 by smiling, the configuration system 100 spots approximately the same key points from the user 20 and records the positional changes over the user's smile. The user's smile track function is represented as Ftn. The configuration system 100 applies the DTW technique to calculate a deviation between SFtn and Ftn to obtain a DTW score. If the DTW is within a predefined threshold, it means the user 20 passes the face recognition and the corresponding configuration profile is applied to change the settings of the facilities.

The above example considers positional changes as the basis to obtain the track functions. Nevertheless, persons skilled in the art should understand that other alternatives such as angle changes, distances, etc. can also be used to achieve the same purpose. Additionally, different weightings may be given to different key points. If the confidence level of a particular key point rises, the weighting given to the particular key point is increased as well.

In another embodiment, a machine learning algorithm may embed one or more facial features of the user into a vector in a multiple dimension. The vector is compared with the registered users' facial information in the same way as previously disclosed. The machine learning algorithm may include, with limitation, neural network, principal component analysis (PCA), and auto encoder, etc.

Back to FIG. 1, the control unit 140 of this embodiment may be electrically connected to or wirelessly connected to the image processing module 130 and the storage module 110. The control unit 140 is provided to change/modify the settings of the vehicle facility VF in the vehicle 10 if the condition disclosed above satisfies.

The configuration system 100 of the present invention may further include numbers of sensors disposed on the vehicle 10 (not shown in the diagram) to sense environmental information, such as ambient light, temperature (temperature outside the vehicle 10 and/or temperature inside the vehicle 10), humidity (humidity outside the vehicle 10 and/or humidity inside the vehicle 10) or barometric pressure, etc. The sensors electrically or wirelessly connected to the control unit 140 so that the control unit 140 may modify the settings of the vehicle facility VF not only in accordance with the associated configuration profile but the relevant environmental information. For instance, if the configuration profile includes an adjustment to the room temperature, then the outside temperature may also be considered to the adjustment. Moreover, the configuration system 100 of the present invention may further receive information, such as time, date, seasonal or festival data, calendar, schedules, etc. from a remote cloud or the user's mobile device. The information may also be considered by the configuration system 100 when any modification is made to the facilities in accordance with a configuration profile. For instance, if a modification will be made to the scheme of a dashboard and it is understood, from the information received, that Halloween is coming, not only the user's set configuration profile but also the elements of Halloween (e.g. pumpkins) will be considered when the controlling unit 140 modifies the theme of the dashboard.

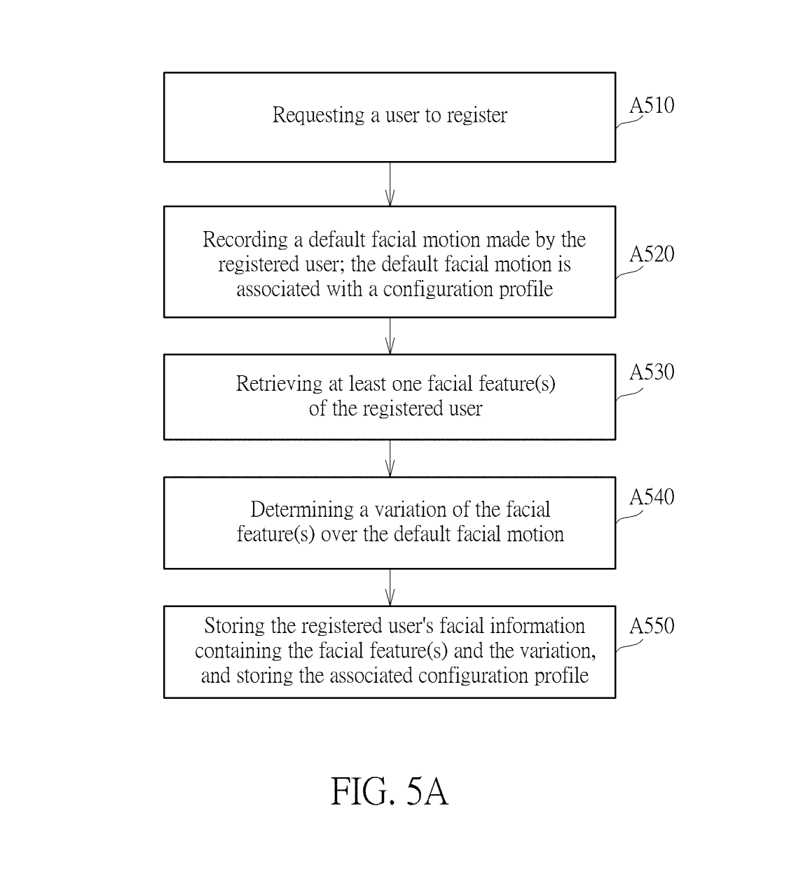

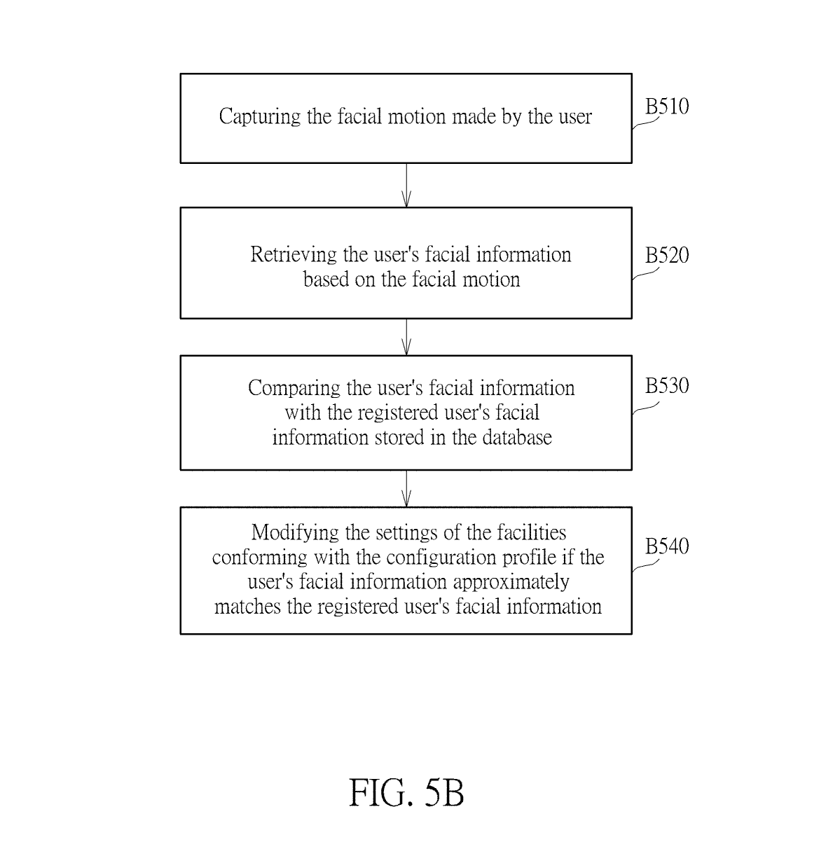

FIG. 5A illustrates an exemplary method of enrollment to establish a database for the configuration system of the disclosed technique. As shown, the steps are as follows:

Step A510: requesting a user to register.

Step A520: recording a default facial motion made by the registered user; the default facial motion is associated with a configuration profile.

Step A530: retrieving at least one facial feature(s) of the registered user.

Step A540: determining a variation of the facial feature(s) over the default facial motion.

Step A550: storing the registered user's facial information containing the facial feature(s) and the variation, and storing the associated configuration profile.

As disclosed previously, the obtaining of the user's facial feature(s) may be from one of the facial image frames contained in the source video clip; alternatively, they may be obtained from a separately captured facial image. Moreover, the facial motion may be a combination of a series of facial expressions. Additionally, the configuration profile relates to one or more settings for one or more chosen facilities installed in a vehicle.

When a user attempts to modify the configurations of the vehicle 10 through the operation of the present invention, he/she may appear in front of the image capture module 120 and make a facial motion. A configuration method in accordance with the present invention is depicted in FIG. 5B and includes the following steps:

Step B510: capturing the facial motion made by the user.

Step B520: retrieving the user's facial information based on the facial motion.

Step B530: comparing the user's facial information with the registered user's facial information stored in the database.

Step B540: modifying the settings of the facilities conforming with the configuration profile if the user's facial information approximately matches the registered user's facial information.

As has been discussed, the method in FIG. 5B may further include retrieving the user's facial information based on the facial motion and verifying if the user is one of the registered users by comparing the user's facial feature (s) with the facial information stored in the database. Similarly, the user's facial feature (s) may be obtained from the image frames of the video clip or it can be separately obtained. Further, the method may also include calculating a variation of the user's facial feature over the facial motion. The user's facial information contains at least the facial feature and the variation of the facial feature over the facial motion. Additionally, a threshold may be set for reference to determine if the user's and the registered user's facial information match. Last but not least, the modification may also consider environmental information as well as other relevant information received from a remote site or the user's mobile device.

Embodiments of the invention may include various operations as set forth above or fewer operations or more operations or operations in an order that is different from the order described. The operations may be embodied in machine-executable instructions that cause a general-purpose or special-purpose processor to perform certain operations. That is, the techniques may be carried out in a computer system or other data processing system in response to its processor, such as a microprocessor, executing sequences of instructions. Such a computer program may be stored or transmitted in a machine-readable medium. A machine-readable medium includes any mechanism that provides (i.e., stores and/or transmits) information in a form accessible by a machine (e.g., a computer, network device, personal digital assistance, manufacturing tool, any device with a set of one or more processors, etc.). For example, a machine readable medium includes recordable/non-recordable storage medium (e.g., any type of disk including floppy disks, optical disks, CD-ROMs, and magnetic-optical disks, read-only memories (ROMs), random access memories (RAMs), EPROMs, EEPROMs, flash memory, magnetic or optical cards, or any type of media suitable for storing electronic instructions), or a machine-readable transmission medium such as, but not limited to, any type of electrical, optical, acoustical or other form of propagated signals (e.g., carrier waves, infrared signals, digital signals, etc.).

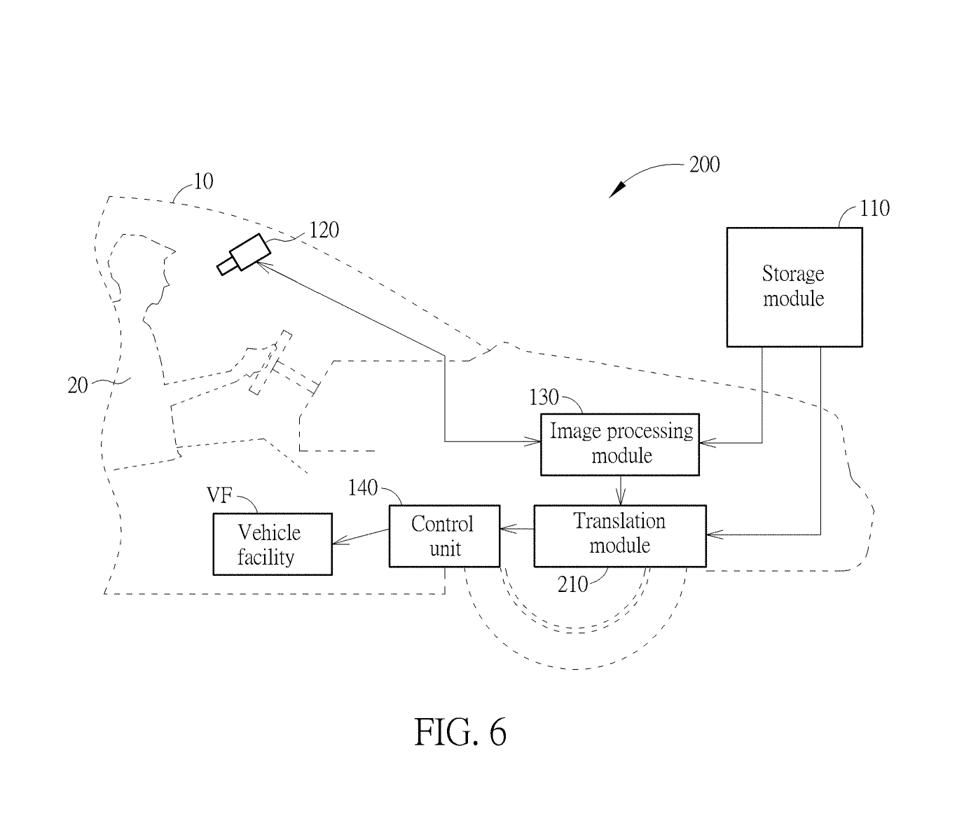

FIG. 6 depicts another exemplary configuration system in accordance with the present invention. In addition to the elements shown in FIG. 1, the instant embodiment further includes a translation module 210. As shown, the translation module 210 is connected to the image processing module 130, the storage module 110, and the control unit 140. The translation module 210 is provided to unify configurations among different vehicles, especially those manufactured by different vendors.

It occurs that different vehicles may have different ways to configure the same facility. For instance, an air conditioner in a first vehicle may be adjusted by a precise number of degree; while in a second vehicle, the temperature is set by rough three different degrees: low-, mid- and high-temperature. To make a configuration profile applicable to either of the two vehicles, there should be some sort of translation among the parameters. Specifically, if, for example, a user A prefers the room temperature remains at 27° C. in a summer season; and the configuration is associated with a facial motion of smiling. When the user A steps into the first vehicle and smiles, because the air conditioner in the first vehicle is capable of adjusting the temperature precisely, through the operation of the disclosed techniques, the temperature can be set to 27° C. accurately. On the other hand, since there are only three temperature degrees provided by the air conditioner in the second vehicle, a translation is made to the configuration parameter. In the instance case, the present invention may interpret 27° C. as falling within the mid-temperature level. Thus, when the User A sitting in the second vehicle and smiles, the room temperature is set to mid-temperature.

The above is a mere example demonstrating how the translation module 210 works. It should be noted that the more facilities involved, the more complicate a translation could be. Thus, preferably, the translation module 210 may maintain a translation table to correspond configuration parameters; alternatively, there may be a set of rules for interpreting the parameters among various vendors.

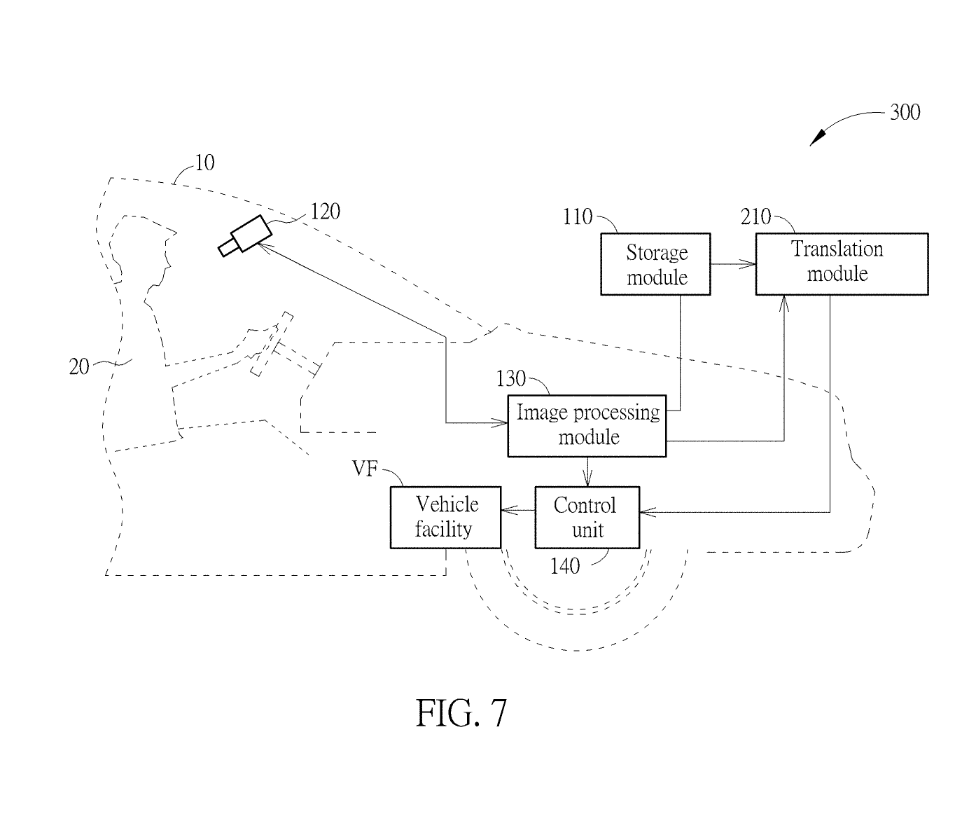

FIG. 7 is another embodiment of a configuration system in accordance with the present invention. As demonstrated, the storage module 110 and the translation module 210 are not disposed in the vehicle 10 but placed remotely. Those components may communicate with the others via a binding communication protocol, such as a telecommunication network.

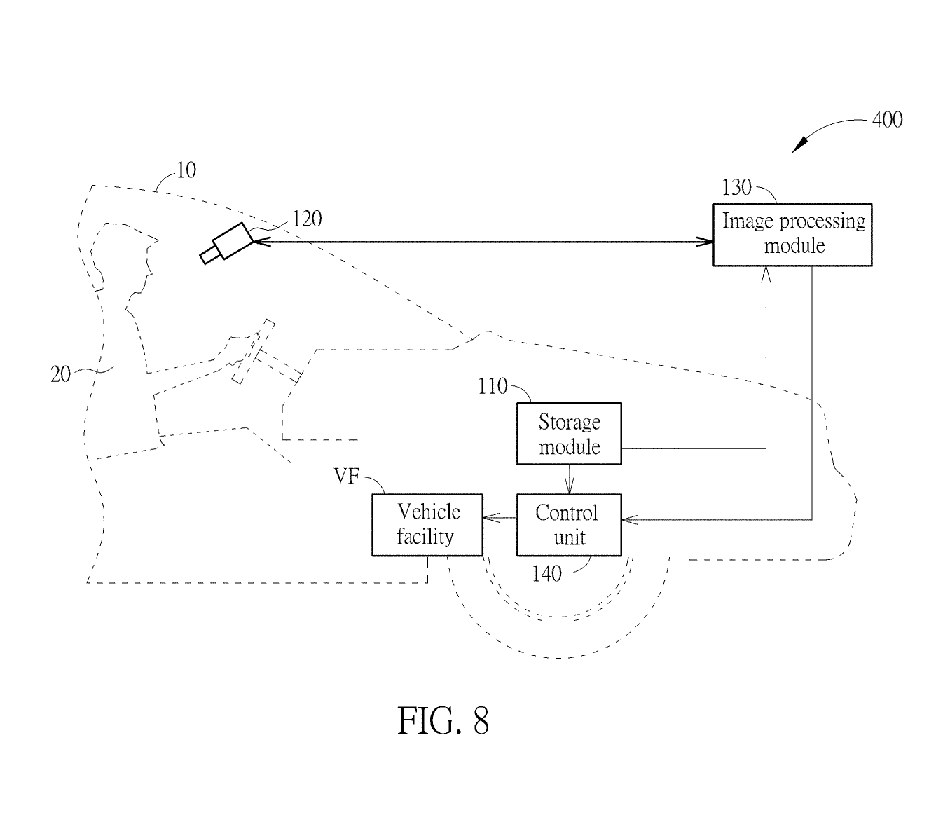

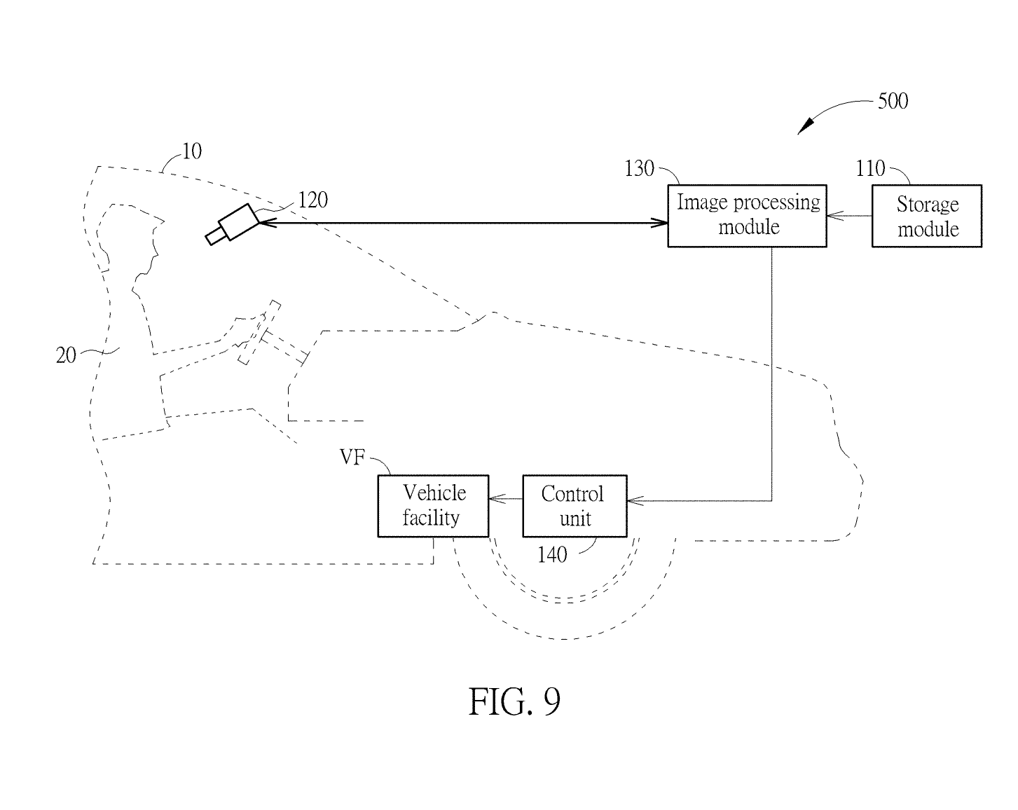

Alternatively, as shown in FIG. 8, the image processing module 130 may be disposed on a remote site and communicates with the other modules through some sort of communication arrangement. Similarly, as depicted in FIG. 9, aside from the image processing module 130, the storage module 110 is also placed remotely as well.

The disclosed methods, apparatus, and systems should not be construed as limiting in any way. Instead, the present disclosure is directed toward all novel and nonobvious features and aspects of the various disclosed embodiments, alone and in various combinations and with one another. The disclosed methods, apparatus, and systems are not limited to any specific aspect or feature or combination thereof, nor do the disclosed embodiments require that any one or more specific advantages be present or problems be solved. The techniques and solutions described in this application can be used in various combinations to provide an improved user experience with vehicles.

In view of the many possible embodiments to which the principles of the disclosed technology may be applied, it should be recognized that the illustrated embodiments are only preferred examples and should not be taken as limiting the scope of the disclosure. Rather, the scope of the disclosure is defined by the following claims and their equivalents. We therefore claim all that comes within the scope of these claims and their equivalents.

What is claimed is:

1. A configuration system for configuring at least one facility in a vehicle, comprising:
a storage module provided to store at least one registered user's facial information and at least one configuration profile, wherein the configuration profile is associated with a default facial motion made by the registered user and the facility's setting;
an image capture module provided to capture a facial motion made by a user;
an image processing module connected to the image capture module and the storage module, wherein the image processing module is provided to determine the user's facial information based on the facial motion, and further to compare the user's facial information with the registered user's facial information; and
a control unit connected to the image processing module, wherein the control unit is provided to modify the facility's setting conforming with the configuration profile if the user's facial information approximately matches the registered user's facial information.

2. The configuration system of claim 1, wherein the registered user's facial information contains the registered users' at least one facial feature and a variation of the facial feature over the default facial motion.

3. The configuration system of claim 1, wherein the user's facial information contains the user's at least one facial feature and a variation of the facial feature over the facial motion.

4. The configuration system of claim 1, wherein the image processing module applies a dynamic time wrapping technique to determine if the user's facial information approximately matches the registered user's facial information.

5. The configuration system of claim 1, wherein the configuration system verifies the user as the registered user if the user's facial information matches the registered user's facial information.

6. The configuration system of claim 1, wherein the default facial motion and the facial motion may be constituted by a series of facial expressions.

7. The configuration system of claim 1, further comprising a translation module provided to translate the configuration profile to be applicable to another vehicle.

8. A method for configuring at least one facility in a vehicle, comprising:
storing facial information of at least one registered user and at least a configuration profile, wherein the configuration profile is associated with a default facial motion made by the registered user and the facility's setting;
capturing a facial motion made by a user;
retrieving the user's facial information based on the facial motion;
comparing the user's facial information with the registered user's facial information; and
modifying the facility's setting conforming with the configuration profile if the user's facial information approximately matches the registered user's facial information.

9. The method of claim 8, further comprising:
retrieving at least facial feature of the registered user; and
calculating a variation of the registered user's facial feature over the default facial motion;
wherein the registered user's facial information contains the registered user's facial feature and the variation of the facial feature over the default facial motion.

10. The method of claim 8, further comprising:
retrieving at least facial feature of the user; and
calculating a variation of the user's facial feature over the facial motion;
wherein the user's facial information contains the user's facial feature and the variation of the facial feature over the facial motion.

11. The method of claim 8, further comprising: applying a dynamic time wrapping technique to determine if the user's facial information approximately matches the registered user's facial information.

12. The method of claim 8, further comprising: verifying the user as the registered user if the user's facial information matches the registered user's facial information.

13. The method of claim 8, wherein the registered user makes a series of facial expressions to constitute the default facial motion; wherein the user makes a series of facial expressions to constitute the facial motion.

14. The method of claim 8, further comprising: translating the configuration profile to be applicable to a second vehicle.

15. A non-transitory machine-readable storage medium including instructions which, when performed by one or more processors, cause the one or more processors to perform a method on an electronic device having a camera for configuring at least one facility in a vehicle, the method comprising:
storing facial information of at least one registered user and at least a configuration profile, wherein the configuration profile is associated with a default facial motion made by the registered user and the facility's setting;
capturing a facial motion made by a user;
retrieving the user's facial information based on the facial motion;
comparing the user's facial information with the registered user's facial information; and
modifying the facility's setting conforming with the configuration profile if the user's facial information approximately matches the registered user's facial information.

16. The medium of claim 15, further comprising:
retrieving at least facial feature of the registered user; and
calculating a variation of the registered user's facial feature over the default facial motion;
wherein the registered user's facial information contains the registered user's facial feature and the variation of the facial feature over the default facial motion.

17. The medium of claim 15, further comprising:
retrieving at least facial feature of the user; and
calculating a variation of the user's facial feature over the facial motion;
wherein the user's facial information contains the user's facial feature and the variation of the facial feature over the facial motion.

18. The medium of claim 15, further comprising: applying a dynamic time wrapping technique to determine if the user's facial information approximately matches the registered user's facial information.

19. The medium of claim 15, further comprising: verifying the user as the registered user if the user's facial information matches the registered user's facial information.

20. The medium of claim 15, further comprising: translating the configuration profile to be applicable to a second vehicle.
